(19) United States
(12) Patent Application Publication
(10) Pub. No.: US 2012/0059554 A1
(43) Pub. Date: Mar. 8, 2012

(54) Automatic Blade Control System during a Period of a Global Navigation Satellite System ...

(75) Inventors: Alexander N. Omelchenko, Moscow (RU); Alexey V. Zhdanov, Moscow (RU)

(73) Assignee: TOPCON POSITIONING SYSTEMS, INC., Livermore, CA (US)

(21) Appl. No.: 13/207,469

(22) Filed: Aug. 11, 2011

Related U.S. Application Data
(60) Provisional application No. 61/379,465, filed on Sep. 2, 2010.

(51) Int. Cl. E02F 1/00; E02F 3/84; G06F 19/00

(52) U.S. Cl. 701/50

(57) ABSTRACT

For precision grading of terrain by a dozer, the dozer blade can be automatically controlled based on measurements from a combination of a global navigation satellite system real-time kinematic mode (GNSS RTK) system and inertial sensors. At least one GNSS sensor and at least one inertial sensor are mounted on the dozer. Control algorithms are based on blade elevation and blade slope angle. During a period of GNSS RTK system outage, control of blade elevation is not available. Blade control is maintained by switching to control algorithms based on blade slope angle and blade pitch angle. Blade slope angle and blade pitch angle are controlled based on extrapolated target values of blade slope angle and blade pitch angle. The extrapolated target values of the angles are extrapolated from target values of the angles prior to the GNSS RTK system outage with the use of a distance travelled by the dozer.

This application claims the benefit of U.S. Provisional Application No. 61/379,465 filed Sep. 2, 2010, which is incorporated herein by reference.

### BACKGROUND OF THE INVENTION

The present invention relates generally to earth-grading machines, and more particularly to an automatic blade control system for dozers.

Global navigation satellite system (GNSS) sensors can determine locations with high accuracy. Currently deployed global navigation satellite systems include the United States Global Positioning System (GPS) and the Russian GLONASS. Other global navigation satellite systems, such as the European GALILEO system, are under development. In a GNSS, a navigation receiver receives and processes radio signals transmitted by satellites located within a line-of-sight distance of the navigation receiver. The satellite signals include carrier signals modulated by pseudo-random binary codes. The navigation receiver measures the time delays of the received signals relative to a local reference clock or oscillator. Code measurements enable the navigation receiver to determine the pseudo-ranges between the navigation receiver and the satellites. The pseudo-ranges differ from the actual ranges (distances) between the navigation receiver and the satellites due to various error sources and due to variations in the time scales of the satellites and the navigation receiver. If signals are received from a sufficiently large number of satellites, then the measured pseudo-ranges can be processed to determine the code coordinates and time scales at the navigation receiver. This operational mode is referred to as a stand-alone mode, since the measurements are determined by a single navigation receiver. A stand-alone system typically provides meter-level accuracy.

To improve the accuracy, precision, stability, and reliability of measurements, differential navigation (DN) systems have been developed. In a DN system, the position of a user is determined relative to a base station (also referred to as a base) whose coordinates are precisely known (for example, by precision GNSS measurements collected over an extended period of time or by surveying measurements). The base contains a navigation receiver that receives satellite signals. The user, whose position is to be determined, can be stationary or mobile and is often referred to as a rover. The rover also contains a navigation receiver that receives satellite signals. Signal measurements processed at the base are transmitted to the rover via a communications link. The communications link, for example, can be provided over a cable or optical fiber. To accommodate a mobile rover, the communications link is often a wireless link.

The rover processes the measurements received from the base, along with measurements taken with its own navigation receiver, to improve the accuracy of determining its position. Accuracy is improved in the differential navigation mode because errors incurred by the navigation receiver at the rover and by the navigation receiver at the base are highly correlated. Since the coordinates of the base are accurately known, measurements from the base can be used to accurately compute the coordinates of the rover. A differential global positioning system (DGPS) computes locations based on pseudo-ranges only.

The location determination accuracy of a differential navigation system can be further improved by supplementing the code pseudo-range measurements with measurements of the phases of the satellite carrier signals. If the carrier phases of the signals transmitted by the same satellite are measured by both the navigation receiver at the base and the navigation receiver at the rover, processing the two sets of carrier phase measurements can yield a location determination accuracy to within several percent of the carrier's wavelength. A differential navigation system that computes locations based on real-time carrier signals, in addition to the code pseudo-ranges, is often referred to as a GNSS real-time kinematic (RTK) mode system (GNSS RTK system).

GNSS sensors, either alone or in combination with other sensors, have been used for control of earth-moving equipment. In particular, GNSS RTK systems can provide sufficiently high accuracy (on the order of one centimeter) for precision grading operations. For example, a combination of a GNSS RTK system and inertial sensors can be used to automatically control the blade of a dozer for precision grading operations. If there is a GNSS RTK system outage, however, precise control is lost. Method and apparatus for maintaining precise control during a GNSS RTK system outage would be advantageous.

### BRIEF SUMMARY OF THE INVENTION

For precision grading of terrain by a dozer, the dozer blade is automatically controlled based on measurements from a combination of a global navigation satellite system real-time kinematic mode (GNSS RTK) system and inertial sensors. At least one GNSS sensor and at least one inertial sensor are mounted on the dozer. The dozer blade elevation and the dozer blade slope angle are controlled during periods of normal GNSS RTK system operation. Accurate control of the dozer blade is typically lost during a GNSS RTK system outage. In an embodiment of the invention, accurate blade control is maintained during a period of GNSS RTK system outage by controlling the dozer blade slope angle and the dozer blade pitch angle. The dozer blade slope angle and the dozer blade pitch angle are controlled based on an extrapolated target value of the dozer blade slope angle and an extrapolated target value of the dozer blade pitch angle. The extrapolated target values of the angles are extrapolated from target values of the angles prior to the GNSS RTK system outage with the use of a distance travelled by the dozer. The dozer blade slope angle and the dozer blade pitch angle are measured by various combinations of inertial sensors and hydraulic cylinder stroke sensors.

In one embodiment, at least one GNSS sensor and at least one inertial sensor are mounted on the dozer blade. In a second embodiment, at least one GNSS sensor and at least one inertial sensor are mounted on the dozer body, and at least one stroke sensor is operatively coupled to at least one hydraulic cylinder controlling the dozer blade. In a third embodiment, at least one GNSS sensor and at least one inertial sensor are mounted on the dozer body, and at least one inertial sensor is mounted on the dozer blade.

These and other advantages of the invention will be apparent to those of ordinary skill in the art by reference to the following detailed description and the accompanying drawings.

### BRIEF DESCRIPTION OF THE DRAWINGS

FIG. 1 shows a schematic of a GNSS RTK system;

FIG. 2A shows a schematic of a dozer geometry and associated reference frames;

FIG. 2B shows a schematic of a first embodiment of a dozer system configuration;

FIG. 3 shows a schematic of a blade pitch angle control algorithm;

FIG. 4 shows a flowchart of a method for automatic blade control during a period of GNSS RTK system outage;

FIG. 5A shows a schematic of a second embodiment of a dozer system configuration;

FIG. 5B shows a schematic of a third embodiment of a dozer system configuration;

FIG. 6A and FIG. 6B show schematics of reference coordinate systems and reference vectors for the second embodiment of a dozer system configuration;

FIG. 7 show a schematic of reference coordinate systems and reference vectors for the third embodiment of a dozer system configuration; and

FIG. 8 shows a schematic of a computational system used for automatic blade control.

### DETAILED DESCRIPTION

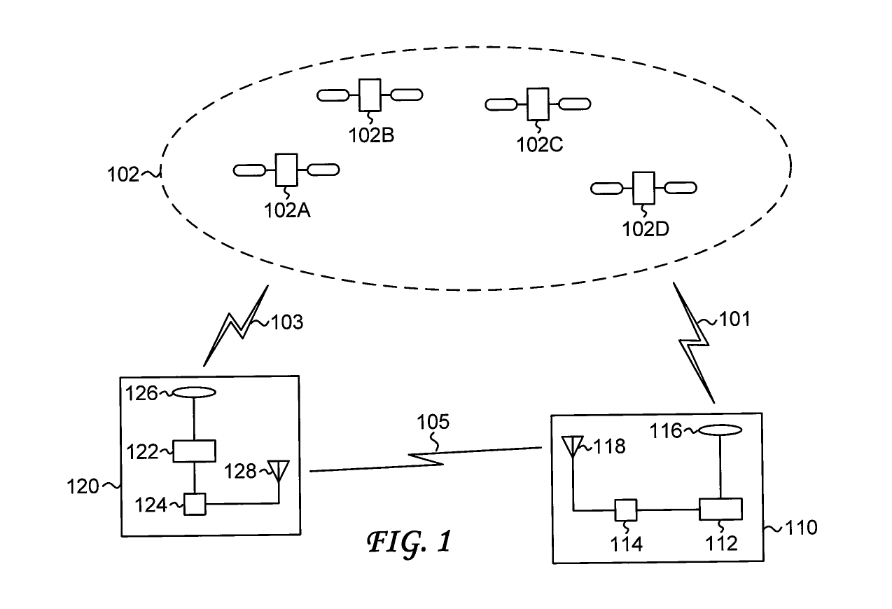

FIG. 1 shows a schematic of a global navigation satellite system (GNSS) real-time kinematic (RTK) mode system; to simplify the terminology, this system is referred to as a GNSS RTK system. The GNSS RTK system includes a base station (also referred to simply as a base) 110, a rover 120, and a constellation 102 of navigation satellites. In general, the base 110 is fixed or stationary, and its coordinates are precisely known. In general, the rover 120 is mobile.

The base 110 includes a navigation receiver 112 and an antenna 116 that receives satellite signals 101 from the constellation 102 of navigation satellites (shown are four representative navigation satellites, denoted navigation satellite 102A—navigation satellite 102D). Similarly, the rover 120 includes a navigation receiver 122 and an antenna 126 that receives satellite signals 103 from the constellation 102. The base 110 further includes a communications transceiver 114 and an antenna 118, and the rover further includes a communications transceiver 124 and an antenna 128. The base 110 and the rover 120 communicate (exchange data) via communication signals 105 that are transmitted and received by the transceiver 114 and the transceiver 124. In an embodiment, communication signals 105 are radiofrequency (RF) signals. Other communications signals, such as free-space optical signals, can be used. Note that FIG. 1 is a simplified high-level schematic; the base 110 and the rover 120 can include additional signal processors and computational units (not shown).

Note that the navigation receiver 122 and the communications transceiver 124 can be two separate units or a single integrated unit. Similarly, the navigation receiver 112 and the communications transceiver 114 can be two separate units or a single integrated unit.

The base 110 calculates its coordinates from the satellite signals 101; similarly, the rover 120 calculates its coordinates from the satellite signals 103. There are errors in calculating the coordinates of the base 110 and the coordinates of the rover 120. Since the coordinates of the base 110 are precisely known in advance, however, the errors in calculating the coordinates of the rover 120 from the satellite signals 103 can be calculated and compensated for. If the base 110 and the rover 120 are sufficiently close, many of the errors (such as satellite clock drift, troposphere delays, and ionosphere delays) in calculating the coordinates of the base 110 and the coordinates of the rover 120 are correlated. Therefore, correction parameters calculated by the base 110 can be used by the rover 120 to improve the accuracy of the coordinates calculated by the rover 120. The correction parameters are transmitted as data from the base 110 to the rover 120 via the communications signals 105.

To determine the coordinates of the rover 120 with high accuracy from a GNSS RTK system, therefore, the rover 120 needs to receive both the satellite signals 103 from the constellation 102 and the communications signals 105 from the base 110 and compute coordinates from the received satellite signals 103 and the received communications signals 105.

Herein, a GNSS RTK solution refers to a set of GNSS coordinates computed by a GNSS RTK algorithm executed by the GNSS receiver in the rover. A period of GNSS RTK outage refers to a time interval during which a GNSS RTK solution is not available.

A period of GNSS RTK system outage can occur for various reasons. Examples of conditions under which a GNSS RTK system outage occurs include the following: (a) the rover 120 moves into a position in which there is poor reception of the satellite signals 103 or the communication signals 105, (b) strong interference disrupts reception of the satellite signals 103 or the communications signals 105 by the rover 120, (c) the navigation receiver 122 in the rover 120 has not locked on to the satellite signals 103, (d) strong interference disrupts reception of the satellite signals 101 by the base 110, (e) the communications signals 105 are not generated and transmitted by the base 110, and (f) there is equipment failure at the base 110 or at the rover 120.

GNSS sensors have been extensively used in the area of construction machine control, particularly in grading applications. Although a control system using only a GNSS sensor for positioning can result in appropriate grading quality in some types of machines, such as graders and scrapers, it has certain limitations in other types of machines. A control system equipped only with GNSS sensors, for example, does not provide accurate control of dozers for grading at high speeds.

Improved machine control can be attained by a control system using a combination of GNSS sensors and other sensors, such as inertial sensors. U.S. Patent Application Publication No. US 2009/0069987, publication date Mar. 12, 2009, referred to herein as “Omelchenko”, which is incorporated by reference herein, describes a control system using a combination of GNSS sensors and inertial sensors to control the blade of a dozer.

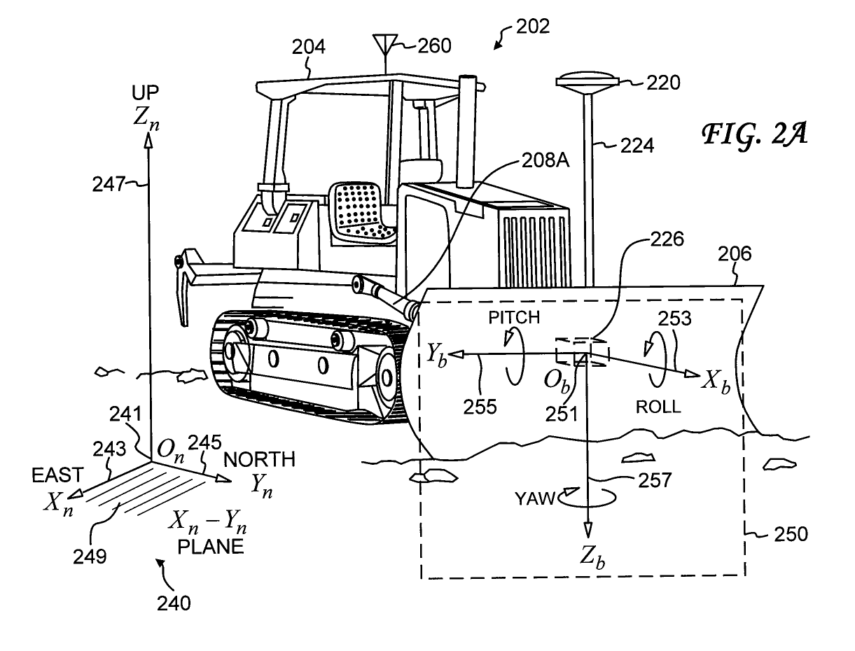

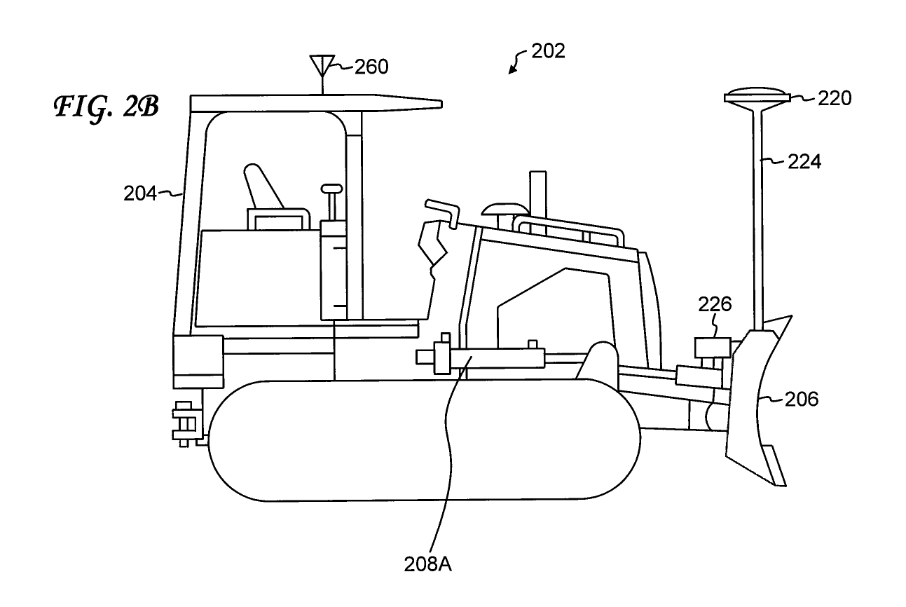

FIG. 2A shows the geometrical reference frames and sensor configuration described in Omelchenko. A dozer 202 includes a dozer body 204 equipped with a dozer blade 206. The dozer body 204 includes the dozer frame and the cabin in which the machine operator sits. The front side of the dozer blade 206 faces away from the dozer body 204. A global navigation satellite system (GNSS) antenna 220 is mounted on a pole 224, which is fixed to the dozer blade 206. In some embodiments, a second GNSS antenna (not shown) is mounted on a pole fixed to the dozer blade 206. An inertial measurement unit (IMU) 226 is installed on the rear side of the dozer blade 206 (facing towards the dozer body 204). A GNSS receiver (not shown) can be installed in the cabin of the dozer body 204. A control box (not shown) can also be installed in the cabin of the dozer body 204. Further details of the control box are discussed below.

In FIG. 2A, the navigation frame 240 is a Cartesian coordinate system used as a local navigation frame. The axes of the navigation frame 240 are denoted ENU [East (Xₙ) 243, North (Yₙ) 245, Up (Zₙ) 247]. The origin of the navigation frame 240 is denoted Oₙ 241; also shown for reference is the Xₙ−Yₙ plane 249. The Xₙ−Yₙ plane 249 is tangent to the World Geodetic System 1984 (WGS-84) Earth ellipsoid. Other local navigation frames can be used.

In FIG. 2A, the blade frame 250 is a Cartesian coordinate system referenced with respect to the dozer blade 206. The orientations of the blade frame axes (X_{b} 253, Y_{b} 255, Z_{b} 257) are fixed with respect to the dozer blade 206. The origin O_{b} 251 is set at a user-defined reference point in the IMU 226. Orientation angles in the blade frame 250 are referenced with respect to rotation about the (X_{b}, Y_{b}, Z_{b}) axes. Rotation in the positive (right-hand rule) direction about the (X_{b}, Y_{b}, Z_{b}) axes are referred to as (blade roll angle, blade pitch angle, blade yaw angle), respectively. Herein, blade roll angle is also referred to as blade slope angle, and blade yaw angle is also referred to as blade heading angle.

In an embodiment, a set of sensors are used for blade control. A GNSS receiver receives signals from the GNSS antenna 220. Two GNSS antennas are used in some embodiments. Herein, GNSS antennas are also referred to as GNSS sensors. The inertial measurement unit IMU 226 includes three orthogonally-placed rate gyros and three orthogonally-placed accelerometers. The accelerometers measure the acceleration vector components of the acceleration along each of the axes (X_{b}, Y_{b}, Z_{b}) in the blade frame 250. The rate gyros measure the angular velocity vector components along each of the axes (X_{b}, Y_{b}, Z_{b}). Herein, rate gyros and accelerometers are also referred to as inertial sensors. In some embodiments, IMU 226 includes additional sensors, such as magnetic compasses.

In the embodiment shown in FIG. 2A, the dozer 202 operates with a GNSS RTK system. For a GNSS RTK system, a communications antenna is mounted on the dozer 202; in the embodiment shown in FIG. 2A, the communications antenna 260 is mounted on the roof of the cabin of the dozer body 204. A communications receiver (not shown) can be installed in the cabin of the dozer body 204.

The parameters to be controlled include the blade elevation and the blade slope angle. To control the blade elevation, the blade elevation and the blade vertical velocity are measured and estimated. To control the blade slope angle, the blade slope angle and the blade slope angular velocity are measured and estimated.

The blade elevation and the orientation of the blade relative to the dozer body are typically controlled by hydraulic cylinders. The blade elevation is typically controlled by two hydraulic cylinders (commonly referred to as the right hydraulic cylinder and the left hydraulic cylinder). The blade pitch angle is also controlled by the blade elevation hydraulic cylinders. The blade assembly is pivoted on the dozer frame; therefore, as the blade elevation is varied, the blade pitch angle is varied. The blade slope angle is typically controlled by one or two hydraulic cylinders; and the blade heading angle is typically controlled by one or two hydraulic cylinders.

The set of all hydraulic cylinders is referred to collectively as the hydraulic cylinders 208. In FIG. 2A, the hydraulic cylinder 208A is shown as a representative hydraulic cylinder. In this instance, the hydraulic cylinder 208A is the right hydraulic cylinder (as viewed from the perspective of the dozer operator sitting in the cabin). Other hydraulic cylinders are not shown.

To measure the blade elevation and the blade vertical velocity, both GNSS RTK data and data from the IMU 226 are used. A period of GNSS RTK system outage, therefore, can directly reduce the accuracy of the blade elevation control. To measure the blade slope angle and the blade slope angular velocity, data only from the IMU 226 is used. A period of GNSS RTK system outage, therefore, does not directly reduce the accuracy of measured values of the blade slope angle and the blade slope angular velocity. In an embodiment described below, however, GNSS RTK data is used to compute the projection of the dozer blade 206 onto a three-dimensional digital terrain model. A three-dimensional digital terrain model represents a set of points, each specified by three coordinates, that map the geometry of the terrain. The projection is then used to generate a blade slope angle reference value, also referred to as a target blade slope angle, which is provided as a reference input into a blade slope angle control system (further details are discussed below). A period of GNSS RTK system outage, therefore, can also reduce the accuracy of the blade slope angle control.

Herein, a target plane includes a set of target values for blade slope angle, blade pitch angle, blade heading angle, and blade elevation. This set of parameters uniquely defines a plane in three-dimensional space; this plane represents a current design plane. A current design plane is a small neighborhood around a point on a digital terrain model; the neighborhood can be considered as flat. Grading is performed along the target plane. The target plane is computed from the projection of the current dozer blade position onto a digital terrain model for a current GNSS epoch and is valid until the next GNSS measurements are available. When a GNSS RTK solution is available, the target plane is updated every GNSS epoch. If automatic steering is not used in the control system, the current heading angle of the dozer blade is used as a target heading angle. If automatic steering is used in the control system, the target heading angle can be computed from the digital terrain model.

Omelchenko describes a control system that controls the blade elevation and the blade slope angle. In embodiments described herein, a control system controls the blade elevation, the blade slope angle, and the blade pitch angle.

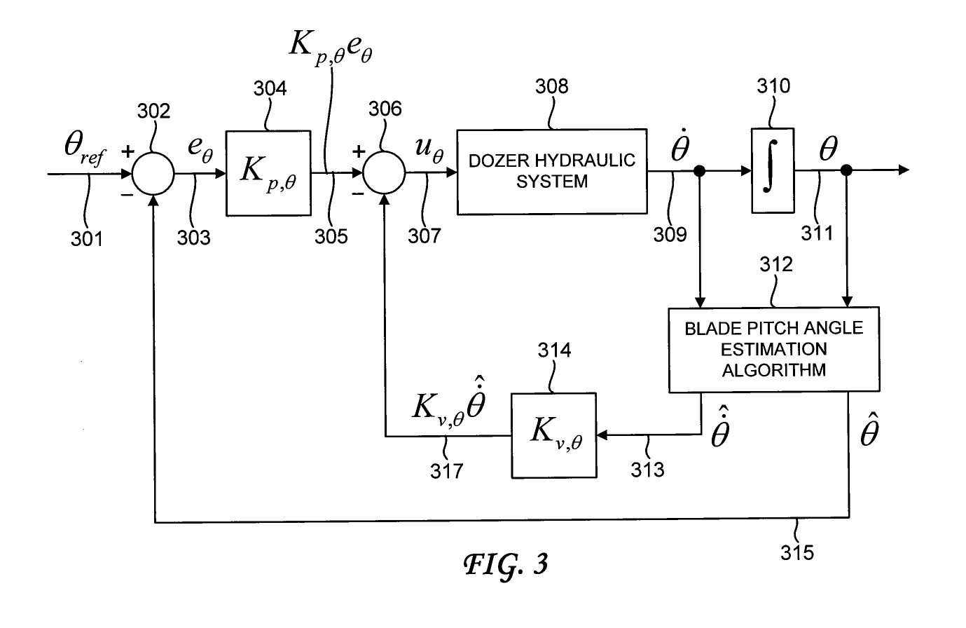

Various control algorithms can be used to control the blade pitch angle. In an embodiment, a proportional-and-derivative (PD) control algorithm is used. FIG. 3 shows a schematic diagram of a PD control algorithm for controlling the blade pitch angle. Note that the value of the blade pitch angle used in the blade pitch angle control system is referenced with respect to the Xₙ−Yₙ plane 249 in the ENU navigation frame 240 (FIG. 2A).

The control signal u_{θ}307 is inputted into a dozer hydraulic system 308 that controls the blade pitch angle θ311. In an embodiment, the dozer hydraulic system 308 controls blade elevation hydraulic cylinders. The blade assembly is pivoted on the dozer frame; therefore, as the blade elevation is varied, the blade pitch angle is varied.

Sensors (described below) measure the blade pitch angular velocity \dot{θ}309, which is inputted into the blade pitch angle estimation algorithm 312. At operation 310, the blade pitch angular velocity \dot{θ}309 is integrated over time to calculate the blade pitch angle θ311, which is also inputted into the blade pitch angle estimation algorithm 312. Measurements of the blade pitch angular velocity and the blade pitch angle can be provided by various sensors. In one embodiment, they are provided by the IMU 226 fixed to the dozer blade 206 (FIG. 2A). The IMU 226 measures the blade pitch angular velocity, which is then integrated by a processing unit to yield the blade pitch angle. In other embodiments, measurements are provided by a combination of stroke sensors installed on hydraulic cylinders and an IMU fixed to the dozer body (further details are discussed below).

The values of the blade pitch angular velocity \dot{θ}309 and the blade pitch angle θ311 include measurement errors. These values are processed by a blade pitch angle estimation algorithm 312 to reduce various errors. Omelchenko provides details of a blade elevation estimation algorithm and a blade slope angle estimation algorithm. A blade pitch angle estimation algorithm can be formulated similar to the blade slope angle estimation algorithm.

The outputs of the blade pitch angle estimation algorithm 312 are the blade pitch angular velocity estimate {dot over (\hat{θ}313 and the blade pitch angle estimate \hat{θ}315. At operation 314, the blade pitch angular velocity estimate {dot over (\hat{θ}313 is multiplied by the velocity control gain K_{v,θ} to yield the product K_{v,θ}{dot over (\hat{θ}317.

The control signal u_{θ} 307 is calculated as follows. The input θ_{ref} 301 represents the reference (desired or target) value of the blade pitch angle. At operation 302, the blade pitch angle estimate \hat{θ}315, previously calculated by the blade pitch angle estimation algorithm 312, is subtracted from the reference blade pitch angle θ_{ref} 301 to yield the blade pitch angle error e_{θ} 303. At operation 304, the blade pitch angle error e_{θ} 303 is multiplied by the proportional control gain K_{p,θ} to yield the product K_{p,θ}e_{θ} 305. At operation 306, the product K_{v,θ}{dot over (\hat{θ} 317 is subtracted from the product K_{p,θ}e_{θ} 305 to yield the control signal u_{θ} 307.

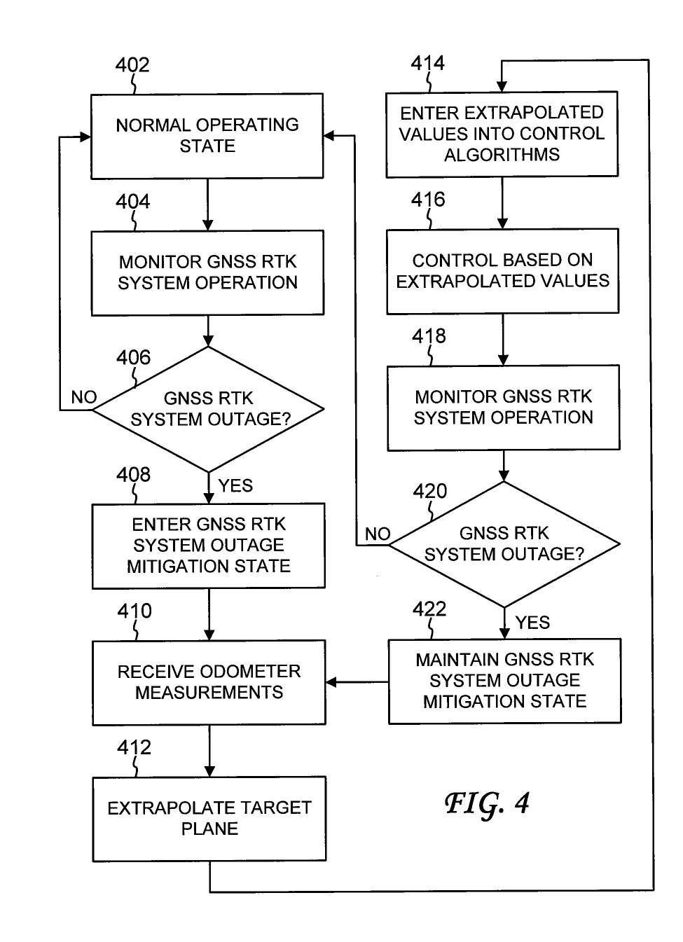

FIG. 4 shows a flowchart of a method for controlling the blade during a period of GNSS RTK system outage. The blade control system is initially in the normal operating state 402: (a) GNSS RTK system is operational, (b) the blade slope angle controller is in the active state, (c) the blade elevation controller is in the active state, (d) the blade pitch angle controller is in the inactive state, and (e) the blade slope angle reference value and the blade elevation reference value are selected from the target plane. The process then passes to step 404, in which GNSS RTK system operation is monitored.

In the decision step 406, if there is no GNSS RTK system outage, then the blade control system maintains the normal operating state 402. If there is a GNSS RTK system outage, then the blade control system enters the GNSS RTK system outage mitigation state, in which (a) the blade slope angle controller is in the active state, (b) the blade elevation controller is in the inactive state, (c) the blade pitch angle controller is in the active state, and (d) the blade slope reference angle value and the blade pitch angle reference value are selected from the target plane.

Prior to a GNSS RTK system outage, the dozer blade is positioned by a control action at a correct target blade elevation value and a correct target blade pitch angle value. When a GNSS RTK system outage occurs, switching from blade elevation control to blade pitch angle control will exclude GNSS RTK data from the blade control process and will allow for smooth continuation of grading operation across the period of GNSS RTK system outage.

When GNSS RTK data is not available, the digital terrain model cannot be used. In an embodiment, an extrapolation mode is enabled to update the target plane based on a history of target plane values recorded over a specified period of time prior to the GNSS RTK system outage. The use of the target plane extrapolation requires the knowledge of the distance travelled by the dozer relative to a local navigation frame, such as the ENU navigation frame 240 (FIG. 2A).

During a period of GNSS RTK system outage, the distance travelled by the dozer cannot be computed from GNSS RTK measurements. An additional sensor, referred to as an odometer, is used to provide measurements of the distance travelled by the dozer relative to the ground and, therefore, relative to the ENU navigation frame 240. The additional sensor, which operates independently of GNSS RTK data, is included in the blade control system.

Returning to FIG. 4, in step 410, the blade control system receives odometer measurements. The process then passes to step 412, in which target plane values (target values of blade slope angle, blade pitch angle, and blade heading angle) are extrapolated. The process then passes to step 414, in which the extrapolated values are entered into the control algorithms for blade slope angle control and blade pitch angle control. The process then passes to step 416, in which the blade control system operates based on the extrapolated values. The process then passes to step 418, in which the GNSS RTK system operation is monitored.

In the decision step 420, if there is no longer a GNSS RTK system outage (that is, the GNSS RTK system operation has been re-instated), then the blade control system returns to its normal operating state 402. If the GNSS RTK system outage still continues, then the process passes to step 422, in which the GNSS RTK system outage mitigation state is maintained. The process then returns to step 410, in which updated odometer measurements are received.

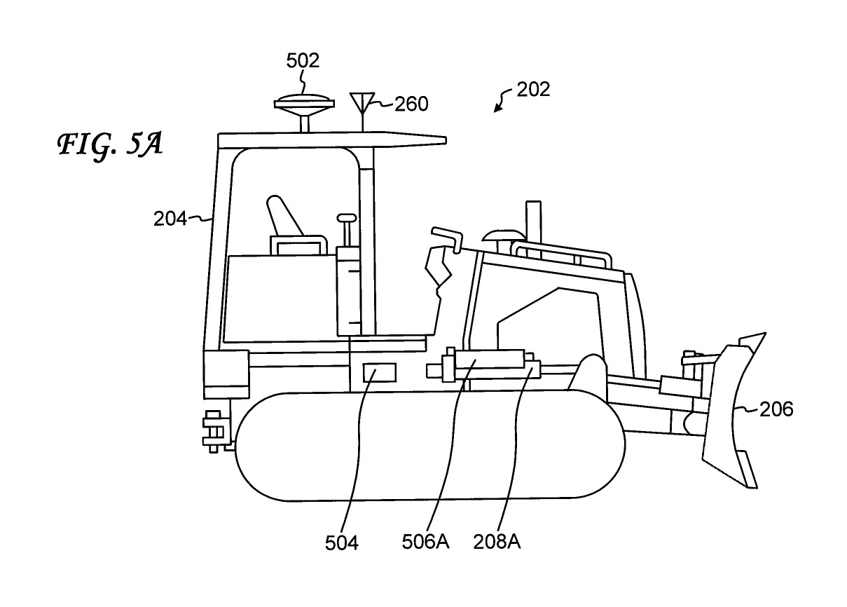

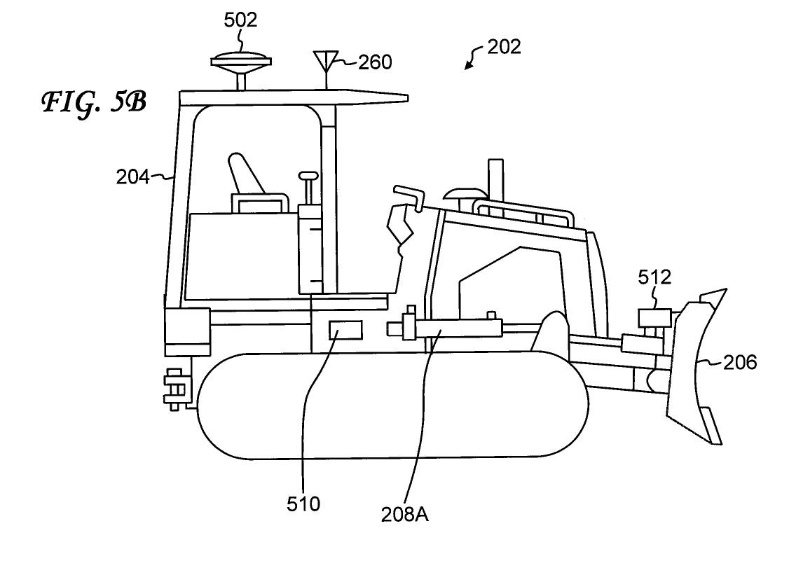

FIG. 2B, FIG. 5A, and FIG. 5B show side views of three different system configurations.

The system configuration shown in FIG. 2B (referred to as System Configuration 1) is the same as that shown in the perspective view of FIG. 2A. The GNSS antenna 220 is mounted on the pole 224, which is fixed to the dozer blade 206. The IMU 226 is fixed to the rear of the dozer blade 206. The position and orientation of the dozer blade 206 relative to a local navigation frame, such as the ENU navigation frame 240, can be computed using measurements from the GNSS antenna 220 and the IMU 226. The blade elevation control algorithm and the blade slope angle control algorithm can be implemented as described in Omelchenko. The blade pitch angle control algorithm can be implemented as described herein. The blade pitch angle is computed from values of the blade pitch angular velocity measured by the IMU 226.

In the system configuration shown in FIG. 5A (referred to as System Configuration 2), the GNSS antenna 502 is mounted on the dozer body 204, and the IMU 504 (similar to the IMU 226 described above) is mounted on the dozer body 204. In the embodiment shown in FIG. 5A, the GNSS antenna 502 is mounted on the roof of the cabin, and the IMU 504 is mounted on the dozer frame. In general, the GNSS antenna 502 and the IMU 504 can be mounted at various user-specified positions on the dozer body 204. More than one GNSS antenna can be mounted on the dozer body.

The hydraulic cylinder 208A is equipped with a stroke sensor 506A, which measures the stroke length of the hydraulic cylinder 208A. Other hydraulic cylinders can be similarly equipped with stroke sensors (the set of stroke sensors is referred to collectively as stroke sensors 506). The position and orientation of the dozer body 204 relative to a local navigation frame, such as the ENU navigation frame 240, can be computed using measurements from the GNSS antenna 502 and the IMU 504. The position and orientation of the dozer blade 206 relative to the dozer body 204, including roll, pitch, and heading angles, and elevation of the blade, as well as rates of change of these parameters, can be computed using measurements from the stroke sensors 506.

In the system configuration shown in FIG. 5B (referred to as System Configuration 3), the GNSS antenna 502 is mounted on the dozer body 204, the IMU-1 510 is mounted on the dozer body 204, and the IMU-2 512 is mounted on the rear of the dozer blade 206. More than one GNSS antenna can be mounted on the dozer body. The IMU-1 510 and the IMU-2 512 are similar to the IMU 226 described above. The position and orientation of the dozer body 204 relative to a local navigation frame, such as the ENU navigation frame 240, can be computed using measurements from the GNSS antenna 502 and the IMU-1 510. The position and orientation of the dozer blade 206 relative to the dozer body 204, including roll, pitch, and heading angles, and elevation of the blade, as well as rates of change of these parameters, can be computed using measurements from the IMU-1 510 and the IMU-2 512.

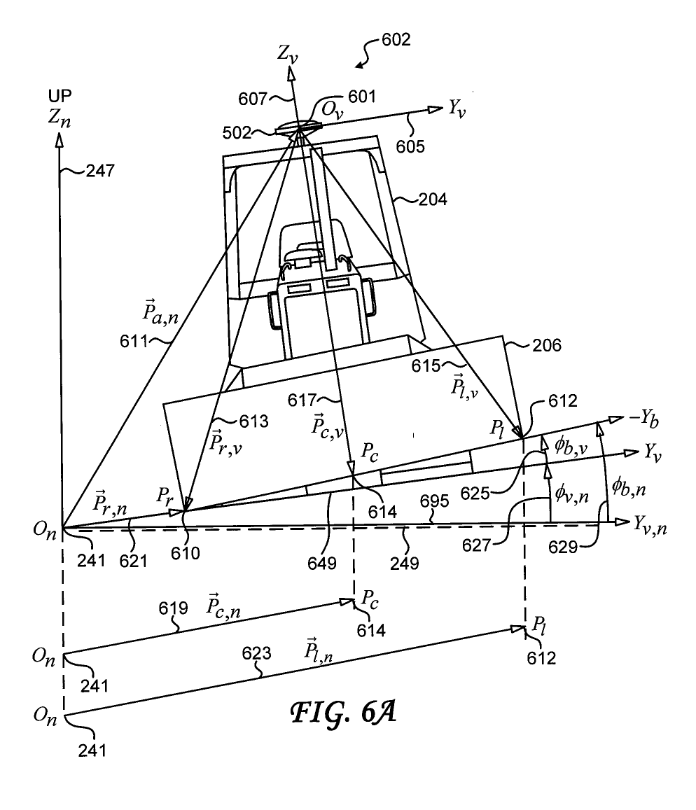

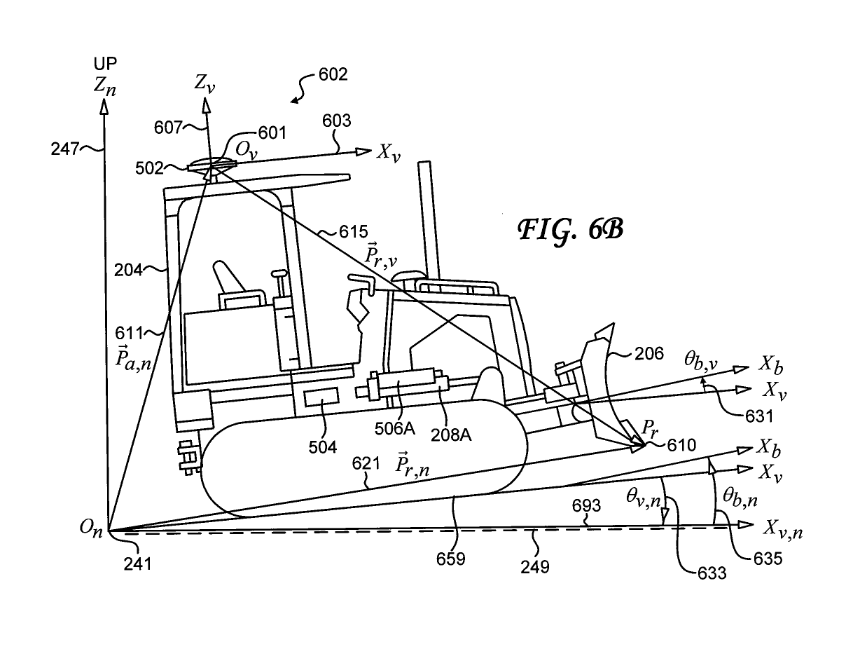

FIG. 6A illustrates the reference coordinate frames and vectors used in blade position and orientation calculations for the System Configuration 2 (FIG. 5A). The dozer geometry is illustrated for a case in which the dozer body 204 is positioned on a surface 649 tilted relative to the Xₙ−Yₙ plane 249 of the navigation frame 240 through a non-zero vehicle slope angle. The dozer blade 206 is rotated through a non-zero blade slope angle relative to the dozer body 204. Algorithms for calculations of various vectors relating to the determination of the dozer blade position and orientation in the System Configuration 2 are described below for a general case, for any orientation of the dozer body 204 relative to the navigation frame 240 and for any orientation of the dozer blade 206 relative to the dozer body 204.

In FIG. 6A, the vehicle frame 602 is a Cartesian coordinate system referenced with respect to the dozer body 204. The orientations of the (Xᵥ, Yᵥ, Zᵥ) axes are fixed relative to the dozer body 204. Shown in FIG. 6A are the Yᵥ-axis 605 and the Zᵥ-axis 607. The Xᵥ-axis 603 (shown in FIG. 6B) points out of the plane of FIG. 6A. The origin Oᵥ 601 is fixed to the phase center of the GNSS antenna 502 mounted on the dozer body 204.

The location of the origin Oᵥ 601 of the vehicle frame 602 relative to the origin Oₙ 241 of the navigation frame 240 is represented by the vector \vec{P}_{a,n} 611, resolved in the navigation frame 240. The location of the right lower blade edge end point Pᵣ 610 relative to the origin Oᵥ 601 is represented by the vector \vec{P}_{r,v} 613, resolved in the vehicle frame 602. The location of the left lower blade edge end point Pₗ 612 relative to the origin Oᵥ 601 is represented by the vector \vec{P}_{l,v} 615, resolved in the vehicle frame 602. (Note that left and right are specified from the perspective of the dozer operator.)

The values of the vectors \vec{P}_{r,v} 613 and \vec{P}_{l,v} 615 are determined from measurements obtained from the stroke sensors 506 with the use of additional measurements of dozer geometric parameters that can be taken during installation of the blade control system onto the dozer. Dozer geometric parameters include, for example, dimensions, locations, and orientations of various mechanical parts (such as the dozer frame, the dozer blade, hydraulic cylinders, GNSS sensors, IMUs, and stroke sensors). The values of the dozer geometric parameters can be stored in a data storage device that is a component of a control box such as the control box described in Omelchenko.

The location of the central point P_{c} 614 of the blade edge relative to the origin Oᵥ 601 is represented by the vector \vec{P}_{c,v} 617, resolved in the vehicle frame 602. The value of the vector \vec{P}_{c,v} 617 is computed as follows:

$${\vec{P}}_{c , v} = \frac{{\vec{P}}_{r , v} + {\vec{P}}_{l , v}}{2} . \qquad ( E1 )$$

The values of the components of the vector \vec{P}_{c,v} 617 can be expressed in the navigation frame 240 by applying a coordinate transformation such as a sequence of Euler angle rotations, including rotations through vehicle roll angle, vehicle pitch angle, and vehicle heading angle. A sequence of Euler angles is a well-known method for coordinate transformation in the field of three-dimensional geometry and is a well-known method used in the field of three-dimensional construction machine control; therefore details are not described herein. Other methods of coordinate transformations, such as quaternions, can be used. The vector \vec{P}_{c,v} expressed in the navigation frame 240 is denoted as \vec{P}_{(c,v)n}.

The location of the central point P_{c} 614 of the blade edge relative to the origin Oₙ 241 is represented by the vector \vec{P}_{c,n} 619, resolved in the navigation frame 240. The value of the vector \vec{P}_{c,n} is computed as follows:

\vec{P}_{c,n}=\vec{P}_{a,n}+\vec{P}_{(c,v)n}. (E2)

The value of the vector \vec{P}_{c,n} can be used for blade elevation estimation and control. Examples of blade elevation estimation and control algorithms are described in Omelchenko.

The location of the right lower blade edge end point Pᵣ 610 relative to the origin Oₙ 241 is represented by the vector \vec{P}_{r,n} 621, resolved in the navigation frame 240. The values of the components of the vector \vec{P}_{r,v} 613 can be expressed in the navigation frame 240 by applying a coordinate transformation such as a sequence of Euler angle rotations, including rotations through vehicle roll angle, vehicle pitch angle, and vehicle heading angle. The vector \vec{P}_{r,v} expressed in the navigation frame 240 is denoted as \vec{P}_{(r,v)n}. The value of the vector \vec{P}_{r,n} is computed as follows:

\vec{P}_{r,n}=\vec{P}_{a,n}+\vec{P}_{r,v)n}. (E3)

The location of the left lower blade edge end point Pₗ 612 relative to the origin Oₙ 241 is represented by the vector \vec{P}_{l,n} 623, resolved in the navigation frame 240. The values of the components of the vector \vec{P}_{l,v} 615 can be expressed in the navigation frame 240 by applying a coordinate transformation such as a sequence of Euler angle rotations, including rotations through vehicle roll angle, vehicle pitch angle, and vehicle heading angle. The vector \vec{P}_{l,v} expressed in the navigation frame 240 is denoted as \vec{P}_{(l,v)n}. The value of the vector \vec{P}_{l,n} is computed as follows:

\vec{P}_{l,n}=\vec{P}_{a,n}+\vec{P}_{(l,v)n}. (E4)

The values of the vectors \vec{P}_{r,n} 621 and \vec{P}_{l,n} 623 can be used to compute projections of the end points of the blade edge onto a digital terrain model.

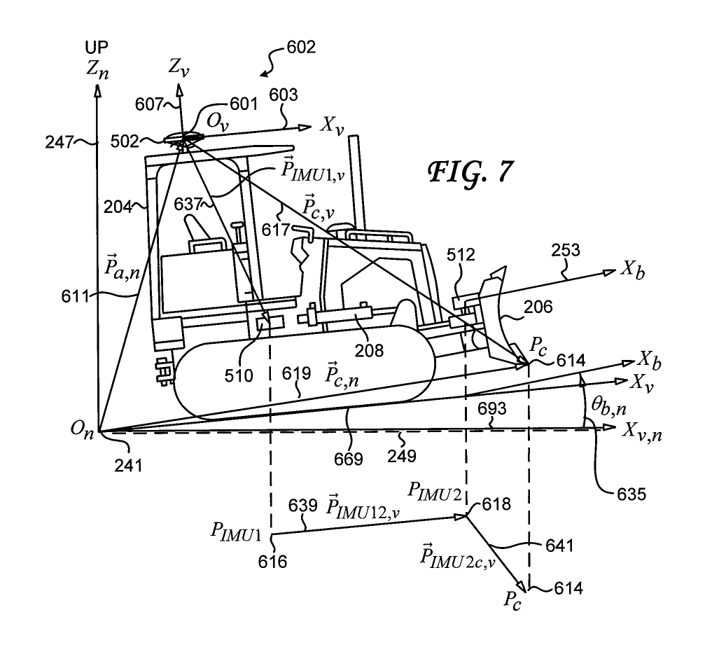

An example of calculation of a slope angle of the dozer blade 204 relative to the navigation frame 240 in the System Configuration 2 is described below for a special case illustrated in FIG. 6A. To simplify the figures, the communications antenna 260 is not shown in FIG. 6A, FIG. 6B, and FIG. 7. The dozer body 204 is positioned on a surface 649 tilted relative to the Xₙ−Yₙ plane 249 of the navigation frame 240 through a non-zero vehicle slope angle, and the value of the vehicle pitch angle is zero. The dozer blade 206 is rotated through a non-zero blade slope angle relative to the dozer body 204, and the value of the blade pitch angle relative to the dozer body 204 is zero.

The slope angle φ_{b,v} 625 of the dozer blade 206 relative to the dozer body 204 is defined as the angle between the −Y_{b} axis aligned with the negative direction of the Y_{b}-axis 255 of the blade frame 250 (FIG. 2A) and the Yᵥ-axis 605 of the vehicle frame 602. The sign of the slope angle φ_{b,v} 625 is determined in accordance with the direction of positive rotation about the X_{b}-axis 253 of the blade frame 250. The value of the slope angle φ_{b,v} 625 is determined from the measurements obtained from the stroke sensors 506 with the use of known values of dozer geometric parameters.

The slope angle φ_{v,n} 627 of the dozer body 204 relative to the Xₙ−Yₙ plane 249 of the navigation frame 240 is defined as the angle between the Yᵥ-axis 605 and the Y_{v,n}-axis 695 representing the projection of the Yᵥ-axis onto the Xₙ−Yₙ plane 249 of the navigation frame 240. The sign of the slope angle φ_{v,n} is determined in accordance with the direction of positive rotation about the Xᵥ-axis 603 of the vehicle frame 602. The value of the slope angle φ_{v,n} 627 is determined from measurements obtained from the IMU 504 fixed to the dozer body 204.

The slope angle φ_{b,n} 629 of the dozer blade 206 relative to the Xₙ−Yₙ plane 249 of the navigation frame 240 is defined as the angle between the −Y-axis and the Y_{v,n}-axis. The value of the slope angle φ_{b,n} 629 is computed as follows:

φ_{b,n}=φ_{b,v}+φ_{v,n}. (E5)

In a more general case, for any orientation of the dozer body 204 relative to the navigation frame 240 and for any orientation of the dozer blade 206 relative to the dozer body 204, the value of the slope angle φ_{b,n} can be computed in a similar manner through the sequence of the following steps. The value of the slope angle φ_{b,v} is determined from measurements obtained from the stroke sensors 506. The value of the slope angle φ_{v,n} is determined from measurements obtained from the IMU 504 fixed to the dozer body 204. The value of the slope angle φ_{b,n} is then computed from the values of the slope angle φ_{b,v} and the slope angle φ_{v,n}. The value of the slope angle φ_{b,n} can be used for blade slope estimation and control. Examples of blade slope estimation and control algorithms are described in Omelchenko.

FIG. 6B provides details for blade position and orientation calculation in System Configuration 2 under different geometrical conditions. The dozer geometry is illustrated for a case in which the dozer body 204 is positioned on a surface 659 tilted relative to the Xₙ−Yₙ plane 249 of the navigation frame 240 through a non-zero vehicle pitch angle, and the value of the vehicle slope angle is zero. The dozer blade 206 is rotated through a non-zero blade pitch angle relative to the dozer body 204, and the value of the blade slope angle is zero.

An example of a calculation of a pitch angle of the dozer blade 206 relative to the navigation frame 240 in the System Configuration 2 is described below for a special case illustrated in FIG. 6B.

The pitch angle θ_{b,v} 631 of the dozer blade 206 relative to the dozer body 204 is defined as the angle between the X_{b}-axis 253 of the blade frame 250 and the Xᵥ-axis 603 of the vehicle frame 602. The sign of the pitch angle θ_{b,v} 631 is determined in accordance with the direction of positive rotation about the Y_{b}-axis 255 of the blade frame 250. The value of the pitch angle θ_{b,v} 631 is determined from measurements obtained from the stroke sensors 506 with the use of known values of dozer geometric parameters.

The pitch angle θ_{v,n} 633 of the dozer body 204 relative to the Xₙ−Yₙ plane 249 of the navigation frame 240 is defined as the angle between the Xᵥ-axis 603 and the X_{v,n}-axis 693 representing the projection of the Xᵥ-axis 603 onto the Xₙ−Yₙ plane 249 of the navigation frame 240. The sign of the pitch angle θ_{v,n} 633 is determined in accordance with the direction of positive rotation about the Yᵥ-axis 605 of the vehicle frame 602. The value of the pitch angle θ_{v,n} 633 is determined from measurements obtained from the IMU 504 fixed to the dozer body 204.

The pitch angle θ_{b,n} 635 of the dozer blade 206 relative to the Xₙ−Yₙ plane 249 of the navigation frame 240 is defined as the angle between the Y_{b}-axis 253 and the X_{v,n}-axis 693. The value of the pitch angle θ_{b,n} is computed as follows:

θ_{b,n}=θ_{b,v}−θ_{v,n}. (E6)

In a general case, for any orientation of the dozer body 204 relative to the navigation frame 240 and for any orientation of the dozer blade 206 relative to the dozer body 204, the value of the pitch angle θ_{b,n} can be computed in a similar manner through the sequence of the following steps. The value of the pitch angle θ_{b,v} is determined from measurements obtained from the stroke sensors 506. The value of the pitch angle θ_{v,n} is determined from measurements obtained from the IMU 504 fixed to the dozer body 204. The value of the pitch angle θ_{b,n} is then computed from the values of the pitch angle θ_{b,v} and the pitch angle θ_{v,n}.

The value of the pitch angle θ_{b,n} can be used for blade pitch angle estimation and control. The blade pitch angle estimation algorithm can be implemented similar to the blade slope angle estimation algorithm described in Omelchenko. The blade pitch angle control algorithm can be implemented as described herein.

In the System Configuration 3, the position and orientation of the dozer blade relative to the dozer body, including roll, pitch, and heading angles, and the elevation of the blade, as well as the rates of change of these parameters, can be computed using measurements from the IMU-1 510 and the IMU2-512.

FIG. 7 illustrates coordinate frames and vectors used in blade position and orientation calculations in the System Configuration 3. The dozer geometry is illustrated for a case of the dozer body 204 positioned on a surface 669 tilted relative to the Xₙ−Yₙ plane 249 of the navigation frame 240 through a non-zero vehicle pitch angle, and the value of the vehicle slope angle is zero. The dozer blade 206 is rotated through a non-zero blade pitch angle relative to the dozer body 204, and the value of the blade slope angle is zero.

Algorithms for calculations of various vectors relating to the determination of the dozer blade position and orientation in the System Configuration 3 are described for a general case, for any orientation of the dozer body 204 relative to the navigation frame 240 and for any orientation of the dozer blade 206 relative to the dozer body 204.

The location of the origin Oᵥ 601 of the vehicle frame 602 relative to the origin Oₙ 241 of the navigation frame 240 is represented by the vector \vec{P}_{a,n} 611, resolved in the navigation frame 240. The location of the center P_{IMU 1} 616 of the IMU-1 510 relative to the origin Oᵥ 601 is represented by the vector \vec{P}_{IMU 1,v} 637, resolved in the vehicle frame 602. The value of the vector \vec{P}_{IMU 1,v} 637 can be measured during installation of the GNSS antenna 502 and the IMU-1 510 onto the dozer body 204. The value of this vector is constant during the system operation.

The location of the center P_{IMU 2} 618 of the IMU-2 512 relative to the center P_{IMU 1} 616 of the IMU-1 510 is represented by the vector \vec{P}_{IMU 12,v} 639, resolved in the vehicle frame 602. The value of the vector \vec{P}_{IMU 12,v} 639 is determined from measurements obtained from the IMU-1 510 and the IMU-2 512 with the use of additional measurements that can be taken during installation of the IMU-1 510 and the IMU-2 512 onto the dozer body 204. These additional measurements, for example, include a number of measured values of the vector \vec{P}_{IMU 12,v} 639 taken for selected orientations of the dozer blade 206 relative to the dozer body 204. The values of these additional measurements can be stored in a data storage device that is a component of a control box such as the control box described in Omelchenko and can be used during the system operation.

The location of the central point P_{c} 614 of the blade edge relative to the center P_{IMU 2} 618 of the IMU-2 512 is represented by the vector \vec{P}_{IMU 12c,v} 641, resolved in the vehicle frame 602. The value of the vector \vec{P}_{IMU 2c,v} 641 can be measured during the installation of the IMU-2 512 onto the dozer blade 206. The value of this vector is constant during the system operation.

The value of the vector \vec{P}_{c,v} 617 is computed as follows:

\vec{P}_{c,v}=\vec{P}_{IMU 1,v}+\vec{P}_{IMU 12,v}+\vec{P}_{IMU 2c,v}. (E7)

The values of the components of the vector \vec{P}_{c,v} 617 can be expressed in the navigation frame 240 by applying a coordinate transformation such as a sequence of rotations through a sequence of Euler angles, including vehicle roll angle, vehicle pitch angle, and vehicle heading angle. The vector \vec{P}_{c,v} expressed in the navigation frame 240 is denoted as \vec{P}_{(c,v)n}.

The location of the central point P_{c} 614 of the blade edge relative to the origin Oₙ 241 of the navigation frame 240 is described by the vector \vec{P}_{c,n} 619, resolved in the navigation frame 240. The value of the vector \vec{P}_{c,n} 619 is computed as follows:

\vec{P}_{c,n}=\vec{P}_{a,n}+\vec{P}_{(c,v)n}. (E8)

The value of the vector \vec{P}_{c,n} can be used for blade elevation estimation and control. Blade elevation estimation and control algorithms can be implemented as described in Omelchenko.

The values of the blade slope angle φ_{b,n} and the blade pitch angle θ_{b,n} relative to the navigation frame 240 can be determined from measurements obtained from the IMU-2 512 fixed to the dozer blade 206. The value of the blade slope angle φ_{b,n} can be used for blade slope estimation and control. Blade slope estimation and control algorithms can be implemented as described in Omelchenko. The value of the blade pitch angle θ_{b,n} can be used for blade pitch angle estimation and control. The blade pitch angle estimation algorithm can be implemented similar to the blade slope angle estimation algorithm described in Omelchenko. The blade pitch angle control algorithm can be implemented as described herein.

The dozer blade heading angle is important for automatic grading. The dozer body heading angle is important for automatic steering of the dozer. In the System Configuration 2 and the System Configuration 3, the blade heading angle relative to the dozer body is known; therefore, the System Configuration 2 and the System Configuration 3 allow for automatic steering of a dozer while performing automatic grading. Automatic steering capability is not available in the System Configuration 1.

In the System Configuration 2 and the System Configuration 3, the dozer body heading angle can be computed using measurements from a magnetic compass mounted on the dozer body. The magnetic compass, for example, can be installed in the IMU mounted on the dozer body. In combination with the known blade heading angle relative to the dozer body, these measurements allow for the extension of automatic dozer steering operation during periods of GNSS RTK system outage via the extrapolation of the target plane, which includes target heading angle as one of its parameters, based on a recorded history of target plane values over a user-specified period of time prior to GNSS RTK system outage.

In the System Configuration 3, a magnetic compass can also be mounted on the dozer blade to determine the dozer blade heading angle. The magnetic compass, for example, can be installed in the IMU mounted on the dozer blade.

In the System Configuration 1 (FIG. 2A and FIG. 2B), during periods of GNSS RTK system outage, the blade slope angle can be controlled in a manner similar to that described above for the System Configuration 3. Values of the blade slope angle and the blade pitch angle are computed from measurements received from the IMU 226 mounted on the dozer blade 206.

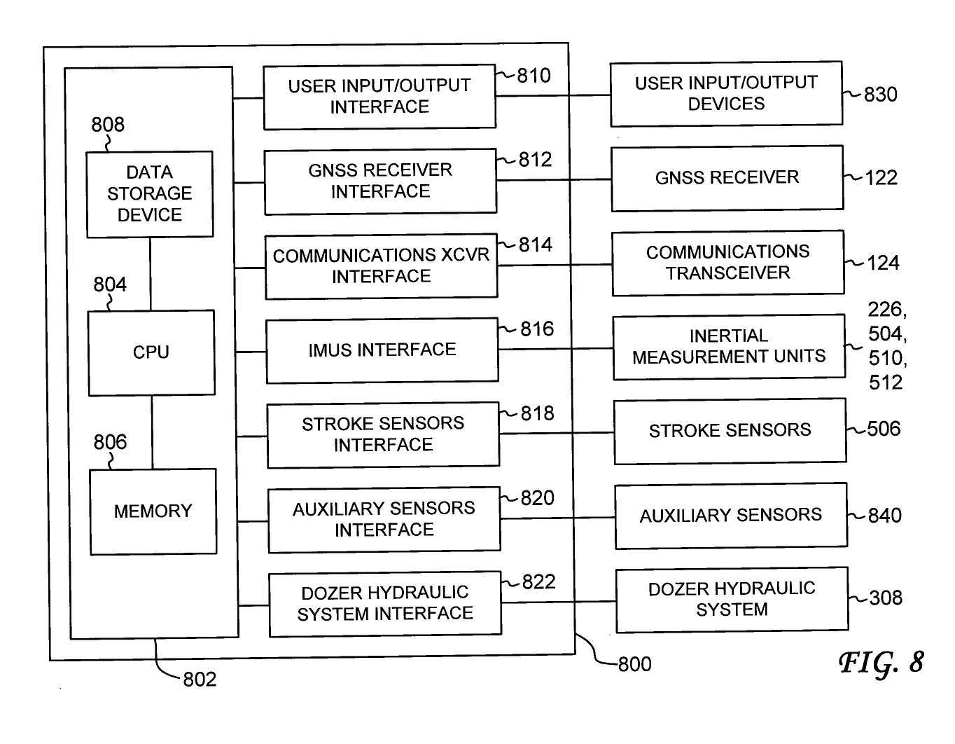

An embodiment of a computational system 800 for implementing an automatic blade control system is shown in FIG. 8. The computational system 800, for example, can be a component of a control box installed in the cabin of the dozer 202. The control box can be configured, programmed, and operated by a control engineer or dozer operator (the dozer operator can be restricted to only a subset of functions). One skilled in the art can construct the computational system 800 from various combinations of hardware, firmware, and software. One skilled in the art can construct the computational system 800 from various electronic components, including one or more general purpose microprocessors, one or more digital signal processors, one or more application-specific integrated circuits (ASICs), and one or more field-programmable gate arrays (FPGAs).

The computational system 800 includes a computer 802, which includes a central processing unit (CPU) 804, memory 806, and a data storage device 808. The data storage device 808 includes at least one persistent, non-transitory, tangible computer readable medium, such as non-volatile semiconductor memory, a magnetic hard drive, or a compact disc read only memory.

The computational system 800 can further include a user input/output interface 810, which interfaces computer 802 to user input/output devices 830. Examples of user input/output devices 830 include a keyboard, a mouse, a local access terminal, and a video display. Data, including computer executable code, can be transferred to and from the computer 802 via the user input/output interface 810.

The computational system 800 can further include a GNSS receiver interface 812, which interfaces the computer 802 with the GNSS receiver 122.

The computational system 800 can further include a communications transceiver (XCVR) interface 814, which interfaces the computer 802 with the communications transceiver 124.

The computational system 800 can further include inertial measurement units interface 816, which interfaces the computer 802 with various inertial measurement units, such as IMU 226, IMU 504, IMU-1 510, and IMU-2 512.

The computational system 800 can further include stroke sensors interface 818, which interfaces the computer 802 with the stroke sensors 506.

The computational system 800 can further include an auxiliary sensors interface 820, which interfaces the computer 802 with auxiliary sensors 840. Examples of auxiliary sensors 840 include odometers and magnetic compasses.

The computational system 800 can further include a dozer hydraulic system interface 822, which interfaces the computer 802 with the dozer hydraulic system 308.

The computational system 800 can further include a communications network interface (not shown), which interfaces the computer 802 with a communications network. Examples of a communications network include a local area network and a wide area network. A user can access the computer 802 via a remote access terminal (not shown) communicating with the communications network. Data, including computer executable code, can be transferred to and from the computer 802 via the communications network interface.

Each of the interfaces described above can operate over different communications media. Examples of communications media include wires, coax cable, optical fibers, free-space optics, and electromagnetic waves (typically in the radiofrequency range and commonly referred to as a wireless interface).

As is well known, a computer operates under control of computer software, which defines the overall operation of the computer and applications. The CPU 804 controls the overall operation of the computer and applications by executing computer program instructions that define the overall operation and applications. The computer program instructions can be stored in the data storage device 808 and loaded into the memory 806 when execution of the program instructions is desired. The automatic blade pitch angle control algorithm shown schematically in FIG. 3 and the automatic blade control method steps shown in the flowchart of FIG. 4 can be defined by computer program instructions stored in the memory 806 or in the data storage device 808 (or in a combination of the memory 806 and the data storage device 808) and controlled by the CPU 804 executing the computer program instructions. For example, the computer program instructions can be implemented as computer executable code programmed by one skilled in the art to perform algorithms. Accordingly, by executing the computer program instructions, the CPU 804 executes the automatic blade pitch angle control algorithm shown schematically in FIG. 3 and the automatic blade control method steps shown in the flowchart of FIG. 4.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for controlling a dozer comprising a dozer body and a dozer blade operatively coupled to the dozer body, the method comprising the steps of:
receiving satellite signals from at least one global navigation satellite system (GNSS) sensor mounted on the dozer;
receiving communications signals from a base station;
computing coordinates in a real-time kinematic (RTK) mode based at least in part on the received satellite signals and the received communications signals;
receiving measurements from at least one inertial sensor mounted on the dozer;
computing an estimate of a dozer blade elevation based at least in part on the computed coordinates and the measurements received from the at least one inertial sensor;
computing an estimate of a dozer blade slope angle based at least in part on the measurements received from the at least one inertial sensor;
controlling the dozer blade elevation and the dozer blade slope angle based at least in part on the computed estimate of the dozer blade elevation and the computed estimate of the dozer blade slope angle;
recording target values of the dozer blade slope angle; and
recording target values of a dozer blade pitch angle;
determining whether a GNSS RTK system outage has occurred; and
upon determining that a GNSS RTK system outage has occurred:
computing a current target value of the dozer blade slope angle based at least in part on the recorded target values of the dozer blade slope angle and a value of a distance travelled by the dozer;
computing a current target value of the dozer blade pitch angle based at least in part on the recorded target values of the blade pitch angle and the value of the distance travelled by the dozer; and
controlling the dozer blade slope angle and the dozer blade pitch angle based at least in part on the current target value of the dozer blade slope angle and the current target value of the dozer blade pitch angle.

2. The method of claim 1, further comprising the step of:
receiving the value of the distance travelled by the dozer from an odometer mounted on the dozer.

3. The method of claim 1, further comprising the steps of:
recording target values of a dozer blade heading angle; and
upon determining that a GNSS RTK system outage has occurred:
computing a current target value of the dozer blade heading angle based at least in part on the recorded target values of the dozer blade heading angle and the value of the distance travelled by the dozer.

4. The method of claim 1, wherein:
the at least one GNSS sensor comprises at least one GNSS sensor mounted on the dozer blade; and
the at least one inertial sensor comprises at least one inertial sensor mounted on the dozer blade.

5. The method of claim 4, further comprising the steps of:
upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates and the measurements received from the at least one inertial sensor; and
computing an estimate of the dozer blade slope angle based at least in part on the measurements received from the at least one inertial sensor; and
upon determining that a GNSS RTK system outage has occurred:
computing an estimate of the dozer blade slope angle based at least in part on the measurements received from the at least one inertial sensor; and
computing an estimate of the dozer blade pitch angle based at least in part on the measurements received from the at least one inertial sensor.

6. The method of claim 1, wherein:
the at least one GNSS sensor comprises at least one GNSS sensor mounted on the dozer body; and
the at least one inertial sensor comprises at least one inertial sensor mounted on the dozer body.

7. The method of claim 6, wherein the dozer blade is operatively coupled to the dozer body by a plurality of hydraulic cylinders, further comprising the step of:
receiving measurements from at least one stroke sensor operatively coupled to at least one hydraulic cylinder.

8. The method of claim 7, further comprising the steps of:
upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates, the measurements received from the at least one inertial sensor, and the measurements received from the at least one stroke sensor; and
computing an estimate of the dozer blade slope angle based at least in part on the measurements received from the at least one inertial sensor and the measurements received from the at least one stroke sensor; and
upon determining that a GNSS RTK system outage has occurred:
computing an estimate of the dozer blade slope angle based at least in part on the measurements received from the at least one inertial sensor and the measurements received from the at least one stroke sensor; and
computing an estimate of the dozer blade pitch angle based at least in part on the measurements received from the at least one inertial sensor and the measurements received from the at least one stroke sensor.

9. The method of claim 8, further comprising the steps of:
upon determining that a GNSS RTK system outage has not occurred:
computing an estimate of a dozer body heading angle based at least in part on the computed coordinates;
computing an estimate of a dozer blade heading angle relative to the dozer body based at least in part on the measurements received from the at least one stroke sensor; and
automatically steering the dozer based at least in part on the computed estimate of the dozer body heading angle and the computed estimate of the dozer blade heading angle relative to the dozer body; and
upon determining that a GNSS RTK system outage has occurred:
receiving measurements of the dozer body heading angle from a magnetic compass mounted on the dozer body;
computing an estimate of the dozer body heading angle based at least in part on the measurements received from the magnetic compass;
computing an estimate of a dozer blade heading angle relative to the dozer body based at least in part on the measurements received from the at least one stroke sensor; and
automatically steering the dozer based at least in part on the computed estimate of the dozer body heading angle and the computed estimate of the dozer blade heading angle relative to the dozer body.

10. The method of claim 1, wherein:
the at least one GNSS sensor comprises at least one GNSS sensor mounted on the dozer body; and
the at least one inertial sensor comprises at least one inertial sensor mounted on the dozer blade and at least one inertial sensor mounted on the dozer body.

11. The method of claim 10, further comprising the steps of:
upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates, the measurements received from the at least one inertial sensor mounted on the dozer blade, and the measurements received from the at least one inertial sensor mounted on the dozer body; and
computing an estimate of the dozer blade slope angle based at least in part on the measurements received from the at least one inertial sensor mounted on the dozer blade; and
upon determining that a GNSS RTK system outage has occurred:
computing an estimate of the dozer blade slope angle based at least in part on the measurements received from the at least one inertial sensor mounted on the dozer blade; and
computing an estimate of the dozer blade pitch angle based at least in part on the measurements received from the at least one inertial sensor mounted on the dozer blade.

12. The method of claim 11, further comprising the steps of:
upon determining that a GNSS RTK system outage has not occurred:
computing an estimate of a dozer body heading angle based at least in part on the computed coordinates;
receiving measurements of a dozer blade heading angle from a magnetic compass mounted on the dozer blade;
computing an estimate of the dozer blade heading angle based at least in part on the measurements received from the magnetic compass; and
automatically steering the dozer based at least in part on the computed estimate of the dozer body heading angle and the computed estimate of the dozer blade heading angle; and
upon determining that a GNSS RTK system outage has occurred:
receiving measurements of a dozer body heading angle from a magnetic compass mounted on the dozer body;
computing an estimate of the dozer body heading angle based at least in part on the measurements received from the magnetic compass mounted on the dozer body;
receiving measurements of a dozer blade heading angle from a magnetic compass mounted on the dozer blade;
computing an estimate of the dozer blade heading angle based at least in part on the measurements received from the magnetic compass mounted on the dozer blade; and
automatically steering the dozer based at least in part on the computed estimate of the dozer body heading angle and the computed estimate of the dozer blade heading angle.

13. An apparatus for controlling a dozer comprising a dozer body and a dozer blade operatively coupled to the dozer body, the apparatus comprising:
means for receiving satellite signals from at least one global navigation satellite system (GNSS) sensor mounted on the dozer;
means for receiving communications signals from a base station;
means for computing coordinates in a real-time kinematic (RTK) mode based at least in part on the received satellite signals and the received communications signals;
means for receiving measurements from at least one inertial sensor mounted on the dozer;
means for computing an estimate of a dozer blade elevation based at least in part on the computed coordinates and the measurements received from the at least one inertial sensor;
means for computing an estimate of a dozer blade slope angle based at least in part on the measurements received from the at least one inertial sensor;
means for controlling the dozer blade elevation and the dozer blade slope angle based at least in part on the computed estimate of the dozer blade elevation and the computed estimate of the dozer blade slope angle;
means for recording target values of the dozer blade slope angle; and
means for recording target values of a dozer blade pitch angle;
means for determining whether a GNSS RTK system outage has occurred; and
means for, upon determining that a GNSS RTK system outage has occurred:
computing a current target value of the dozer blade slope angle based at least in part on the recorded target values of the dozer blade slope angle and a value of a distance travelled by the dozer;
computing a current target value of the dozer blade pitch angle based at least in part on the recorded target values of the blade pitch angle and the value of the distance travelled by the dozer; and
controlling the dozer blade slope angle and the dozer blade pitch angle based at least in part on the current target value of the dozer blade slope angle and the current target value of the dozer blade pitch angle.

14. The apparatus of claim 13, further comprising:
means for receiving the value of the distance travelled by the dozer from an odometer mounted on the dozer.

15. The apparatus of claim 13, further comprising:
means for recording target values of a dozer blade heading angle; and
means for, upon determining that a GNSS RTK system outage has occurred:
computing a current target value of the dozer blade heading angle based at least in part on the recorded target values of the dozer blade heading angle and the value of the distance travelled by the dozer.

16. The apparatus of claim 13, wherein:
the at least one GNSS sensor comprises at least one GNSS sensor mounted on the dozer blade; and
the at least one inertial sensor comprises at least one inertial sensor mounted on the dozer blade.

17. The apparatus of claim 16, further comprising:
means for, upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates and the measurements received from the at least one inertial sensor; and
computing an estimate of the dozer blade slope angle based at least in part on the measurements received from the at least one inertial sensor; and
means for, upon determining that a GNSS RTK system outage has occurred:
computing an estimate of the dozer blade slope angle based at least in part on the measurements received from the at least one inertial sensor; and
computing an estimate of the dozer blade pitch angle based at least in part on the measurements received from the at least one inertial sensor.

18. The apparatus of claim 13, wherein:
the at least one GNSS sensor comprises at least one GNSS sensor mounted on the dozer body; and
the at least one inertial sensor comprises at least one inertial sensor mounted on the dozer body.

19. The apparatus of claim 18, wherein the dozer blade is operatively coupled to the dozer body by a plurality of hydraulic cylinders, further comprising:
means for receiving measurements from at least one stroke sensor operatively coupled to at least one hydraulic cylinder.

20. The apparatus of claim 19, further comprising:
means for, upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates, the measurements received from the at least one inertial sensor, and the measurements received from the at least one stroke sensor; and
computing an estimate of the dozer blade slope angle based at least in part on the measurements received from the at least one inertial sensor and the measurements received from the at least one stroke sensor; and
means for, upon determining that a GNSS RTK system outage has occurred:
computing an estimate of the dozer blade slope angle based at least in part on the measurements received from the at least one inertial sensor and the measurements received from the at least one stroke sensor; and
computing an estimate of the dozer blade pitch angle based at least in part on the measurements received from the at least one inertial sensor and the measurements received from the at least one stroke sensor.

21. The apparatus of claim 20, further comprising:
means for, upon determining that a GNSS RTK system outage has not occurred:
computing an estimate of a dozer body heading angle based at least in part on the computed coordinates;
computing an estimate of a dozer blade heading angle relative to the dozer body based at least in part on the measurements received from the at least one stroke sensor; and
automatically steering the dozer based at least in part on the computed estimate of the dozer body heading angle and the computed estimate of the dozer blade heading angle relative to the dozer body; and
means for, upon determining that a GNSS RTK system outage has occurred:
receiving measurements of the dozer body heading angle from a magnetic compass mounted on the dozer body;
computing an estimate of the dozer body heading angle based at least in part on the measurements received from the magnetic compass;
computing an estimate of a dozer blade heading angle relative to the dozer body based at least in part on the measurements received from the at least one stroke sensor; and
automatically steering the dozer based at least in part on the computed estimate of the dozer body heading angle and the computed estimate of the dozer blade heading angle relative to the dozer body.

22. The apparatus of claim 13, wherein:
the at least one GNSS sensor comprises at least one GNSS sensor mounted on the dozer body; and
the at least one inertial sensor comprises at least one inertial sensor mounted on the dozer blade and at least one inertial sensor mounted on the dozer body.

23. The apparatus of claim 22, further comprising:
means for, upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates, the measurements received from the at least one inertial sensor mounted on the dozer blade, and the measurements received from the at least one inertial sensor mounted on the dozer body; and
computing an estimate of the dozer blade slope angle based at least in part on the measurements received from the at least one inertial sensor mounted on the dozer blade; and
means for, upon determining that a GNSS RTK system outage has occurred:
computing an estimate of the dozer blade slope angle based at least in part on the measurements received from the at least one inertial sensor mounted on the dozer blade; and
computing an estimate of the dozer blade pitch angle based at least in part on the measurements received from the at least one inertial sensor mounted on the dozer blade.

24. The apparatus of claim 23, further comprising:
means for, upon determining that a GNSS RTK system outage has not occurred:
computing an estimate of a dozer body heading angle based at least in part on the computed coordinates;
receiving measurements of a dozer blade heading angle from a magnetic compass mounted on the dozer blade;
computing an estimate of the dozer blade heading angle based at least in part on the measurements received from the magnetic compass; and
automatically steering the dozer based at least in part on the computed estimate of the dozer body heading angle and the computed estimate of the dozer blade heading angle; and
means for, upon determining that a GNSS RTK system outage has occurred:
receiving measurements of a dozer body heading angle from a magnetic compass mounted on the dozer body;
computing an estimate of the dozer body heading angle based at least in part on the measurements received from the magnetic compass mounted on the dozer body;
receiving measurements of a dozer blade heading angle from a magnetic compass mounted on the dozer blade;
computing an estimate of the dozer blade heading angle based at least in part on the measurements received from the magnetic compass mounted on the dozer blade; and
automatically steering the dozer based at least in part on the computed estimate of the dozer body heading angle and the computed estimate of the dozer blade heading angle.

25. A computer readable medium storing computer program instructions for controlling a dozer comprising a dozer body and a dozer blade operatively coupled to the dozer body, the computer program instructions defining the steps of:
receiving satellite signals from at least one global navigation satellite system (GNSS) sensor mounted on the dozer;
receiving communications signals from a base station;
computing coordinates in a real-time kinematic (RTK) mode based at least in part on the received satellite signals and the received communications signals;
receiving measurements from at least one inertial sensor mounted on the dozer;
computing an estimate of a dozer blade elevation based at least in part on the computed coordinates and the measurements received from the at least one inertial sensor;
computing an estimate of a dozer blade slope angle based at least in part on the measurements received from the at least one inertial sensor;
controlling the dozer blade elevation and the dozer blade slope angle based at least in part on the computed estimate of the dozer blade elevation and the computed estimate of the dozer blade slope angle;
recording target values of the dozer blade slope angle; and
recording target values of a dozer blade pitch angle;
determining whether a GNSS RTK system outage has occurred; and
upon determining that a GNSS RTK system outage has occurred:
computing a current target value of the dozer blade slope angle based at least in part on the recorded target values of the dozer blade slope angle and a value of a distance travelled by the dozer;
computing a current target value of the dozer blade pitch angle based at least in part on the recorded target values of the blade pitch angle and the value of the distance travelled by the dozer; and
controlling the dozer blade slope angle and the dozer blade pitch angle based at least in part on the current target value of the dozer blade slope angle and the current target value of the dozer blade pitch angle.

26. The computer readable medium of claim 25, wherein the computer program instructions further comprise computer program instructions defining the step of:
receiving the value of the distance travelled by the dozer from an odometer mounted on the dozer.

27. The computer readable medium of claim 25, wherein the computer program instructions further comprise computer program instructions defining the steps of:
recording target values of a dozer blade heading angle; and
upon determining that a GNSS RTK system outage has occurred:
computing a current target value of the dozer blade heading angle based at least in part on the recorded target values of the dozer blade heading angle and the value of the distance travelled by the dozer.

28. The computer readable medium of claim 25, wherein:
the at least one GNSS sensor comprises at least one GNSS sensor mounted on the dozer blade; and
the at least one inertial sensor comprises at least one inertial sensor mounted on the dozer blade.

29. The computer readable medium of claim 28, wherein the computer program instructions further comprise computer program instructions defining the steps of:
upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates and the measurements received from the at least one inertial sensor; and
computing an estimate of the dozer blade slope angle based at least in part on the measurements received from the at least one inertial sensor; and
upon determining that a GNSS RTK system outage has occurred:
computing an estimate of the dozer blade slope angle based at least in part on the measurements received from the at least one inertial sensor; and
computing an estimate of the dozer blade pitch angle based at least in part on the measurements received from the at least one inertial sensor.

30. The computer readable medium of claim 25, wherein:
the at least one GNSS sensor comprises at least one GNSS sensor mounted on the dozer body; and
the at least one inertial sensor comprises at least one inertial sensor mounted on the dozer body.

31. The computer readable medium of claim 30, wherein the dozer blade is operatively coupled to the dozer body by a plurality of hydraulic cylinders, and wherein the computer program instructions further comprise computer program instructions defining the step of:
receiving measurements from at least one stroke sensor operatively coupled to at least one hydraulic cylinder.

32. The computer readable medium of claim 31, wherein the computer program instructions further comprise computer program instructions defining the steps of:
upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates, the measurements received from the at least one inertial sensor, and the measurements received from the at least one stroke sensor; and
computing an estimate of the dozer blade slope angle based at least in part on the measurements received from the at least one inertial sensor and the measurements received from the at least one stroke sensor; and
upon determining that a GNSS RTK system outage has occurred:
computing an estimate of the dozer blade slope angle based at least in part on the measurements received from the at least one inertial sensor and the measurements received from the at least one stroke sensor; and
computing an estimate of the dozer blade pitch angle based at least in part on the measurements received from the at least one inertial sensor and the measurements received from the at least one stroke sensor.

33. The computer readable medium of claim 32, wherein the computer program instructions further comprise computer program instructions defining the steps of:
upon determining that a GNSS RTK system outage has not occurred:
computing an estimate of a dozer body heading angle based at least in part on the computed coordinates;
computing an estimate of a dozer blade heading angle relative to the dozer body based at least in part on the measurements received from the at least one stroke sensor; and
automatically steering the dozer based at least in part on the computed estimate of the dozer body heading angle and the computed estimate of the dozer blade heading angle relative to the dozer body; and
upon determining that a GNSS RTK system outage has occurred:
receiving measurements of the dozer body heading angle from a magnetic compass mounted on the dozer body;
computing an estimate of the dozer body heading angle based at least in part on the measurements received from the magnetic compass;
computing an estimate of a dozer blade heading angle relative to the dozer body based at least in part on the measurements received from the at least one stroke sensor; and
automatically steering the dozer based at least in part on the computed estimate of the dozer body heading angle and the computed estimate of the dozer blade heading angle relative to the dozer body.

34. The computer readable medium of claim 25, wherein:
the at least one GNSS sensor comprises at least one GNSS sensor mounted on the dozer body; and
the at least one inertial sensor comprises at least one inertial sensor mounted on the dozer blade and at least one inertial sensor mounted on the dozer body.

35. The computer readable medium of claim 34, wherein the computer program instructions further comprise computer program instructions defining the steps of:
upon determining that a GNSS RTK system outage has not occurred:
continuing to receive the satellite signals from the at least one GNSS sensor;
continuing to receive the communications signals from the base station;
computing coordinates in a RTK mode based at least in part on the received satellite signals and the received communications signals;
computing an estimate of the dozer blade elevation based at least in part on the computed coordinates, the measurements received from the at least one inertial sensor mounted on the dozer blade, and the measurements received from the at least one inertial sensor mounted on the dozer body; and
computing an estimate of the dozer blade slope angle based at least in part on the measurements received from the at least one inertial sensor mounted on the dozer blade; and
upon determining that a GNSS RTK system outage has occurred:
computing an estimate of the dozer blade slope angle based at least in part on the measurements received from the at least one inertial sensor mounted on the dozer blade; and
computing an estimate of the dozer blade pitch angle based at least in part on the measurements received from the at least one inertial sensor mounted on the dozer blade.

36. The computer readable medium of claim 35, wherein the computer program instructions further comprise computer program instructions defining the steps of:
upon determining that a GNSS RTK system outage has not occurred:
computing an estimate of a dozer body heading angle based at least in part on the computed coordinates;
receiving measurements of a dozer blade heading angle from a magnetic compass mounted on the dozer blade;
computing an estimate of the dozer blade heading angle based at least in part on the measurements received from the magnetic compass; and
automatically steering the dozer based at least in part on the computed estimate of the dozer body heading angle and the computed estimate of the dozer blade heading angle; and
upon determining that a GNSS RTK system outage has occurred:
receiving measurements of a dozer body heading angle from a magnetic compass mounted on the dozer body;
computing an estimate of the dozer body heading angle based at least in part on the measurements received from the magnetic compass mounted on the dozer body;
receiving measurements of a dozer blade heading angle from a magnetic compass mounted on the dozer blade;
computing an estimate of the dozer blade heading angle based at least in part on the measurements received from the magnetic compass mounted on the dozer blade; and
automatically steering the dozer based at least in part on the computed estimate of the dozer body heading angle and the computed estimate of the dozer blade heading angle.
